(19) United States
(12) Patent Application Publication
(10) Pub. No.: US 2003/0202347 A1
(43) Pub. Date: Oct. 30, 2003

(54) Compact fluorescent light fixture and method of manufacturing same

(75) Inventors: Bentley Chelf, Laguna Nigel (TW); Wang Liang Chou, Taichung City (TW)

Correspondence Address: HAYNES AND BOONE, LLP, 901 MAIN STREET, SUITE 3100, DALLAS, TX, 75202, US

(73) Assignee: General Innovations, LLC, Laguna Nigel, CA

(21) Appl. No.: 10/131,861

(22) Filed: Apr. 24, 2002

(51) Int. Cl. F21S 4/00

(52) U.S. Cl. 362/225; 362/217; 362/265; 362/221; 362/249; 362/260

(57) ABSTRACT

A lighting fixture in which a subhousing for a ballast circuit is disposed between two spaced portions of a bottom plate and a top plate. Sockets are connected to the respective ends of the plates for receiving at least one bulb.

### BACKGROUND

The present invention relates, in general, to a fluorescent lighting fixture having a relatively compact profile, and a method of manufacturing same.

Lighting fixtures for receiving elongated tubular fluorescent bulbs are commonplace and enjoy significant sales, especially in large home improvement stores. However, these type of fixtures are relatively large in size, bulky, awkward and heavy. Therefore, they are relatively hard to install, take up considerable space in use, and are fairly expensive to ship. In the last context, since these fixtures are often shipped in bulk quantities from manufactures to distributors or wholesalers, and from distributors or wholesalers to retailers, the shipping costs considerably add to the cost per unit.

Therefore, what is needed is a fluorescent lighting fixture that has a compact profile and is therefore relatively easy to handle and relatively inexpensive to ship.

### BRIEF DESCRIPTION OF THE DRAWINGS

FIG. 1 is an exploded isometric view of a fluorescent light fixture according to an embodiment of the present invention.

FIG. 2 is an isometric view of the assembled light fixture of FIG. 1.

FIG. 3 is an enlarged sectional view taken along the line 3-3 of FIG. 2.

### DETAILED DESCRIPTION

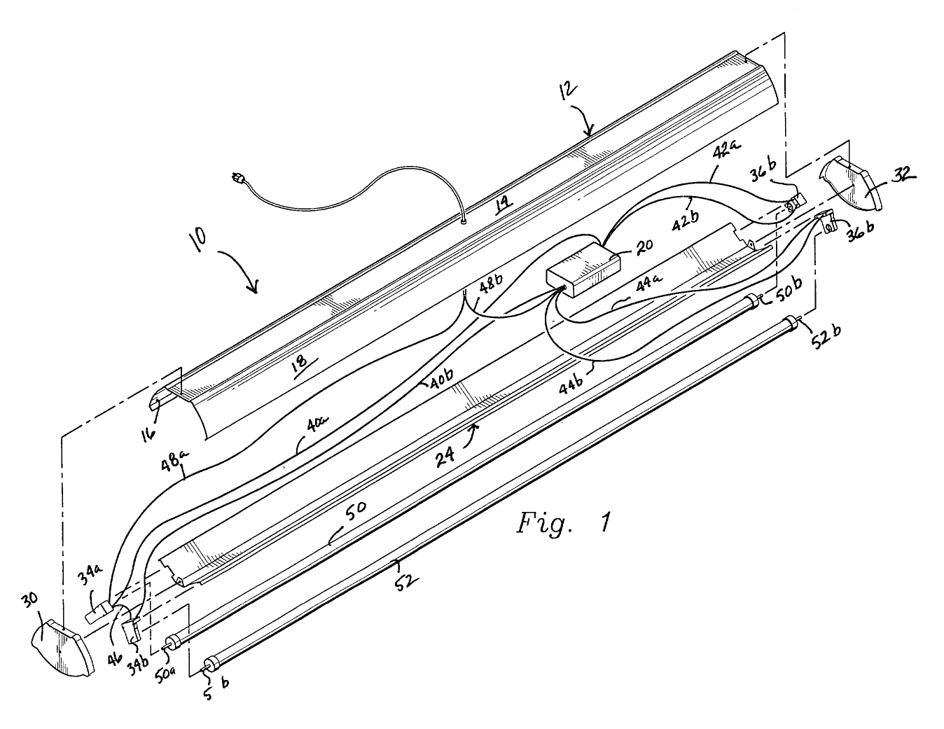

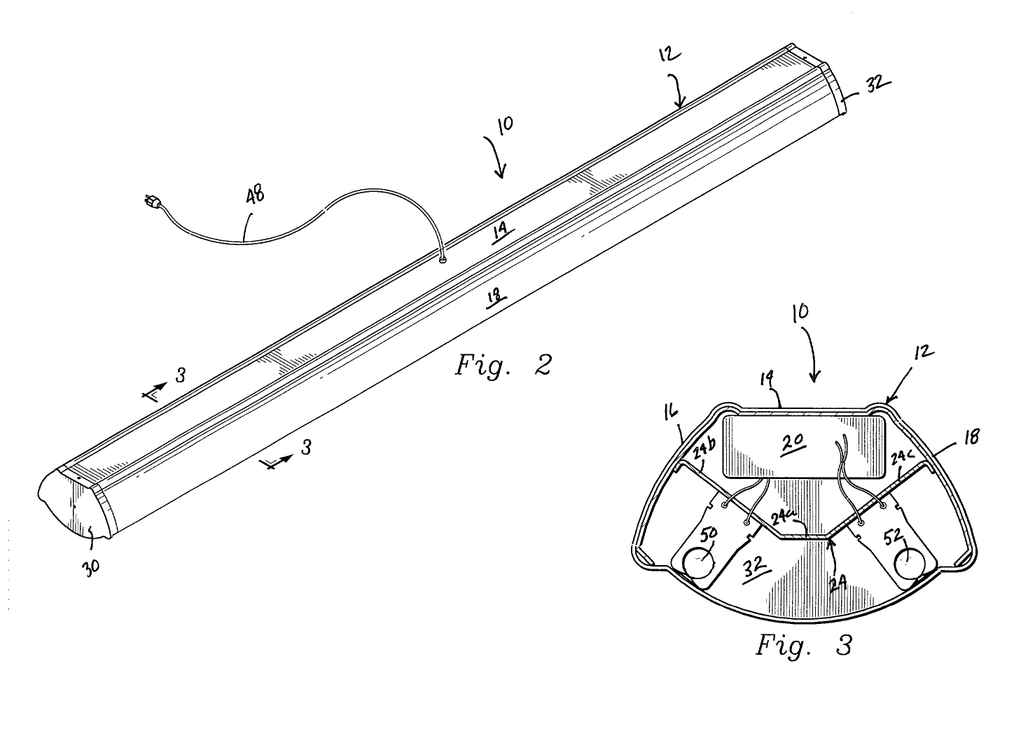

Referring to FIGS. 1-3 of the drawings, the reference numeral 10 refers, in general, to a fluorescent light fixture formed by an elongated flat plate 12 that is bent in two planes to form a center plate 14 and two side plates 16 and 18 extending from the respective sides of the center plate and at an angle to the center plate.

A subhousing 20 is disposed between the ends of the plate 12 and is connected to the inner surface of the center plate 14 in any conventional manner, such as by sheet metal screws, bolts, or the like. As better shown in FIG. 3, the height of the subhousing is less than the height of each side plate 16 and 18, and the width of the subhousing 20 is less than the distance between the side plates. Thus, the subhousing 20 is enveloped by the plates 12, 14, and 16. It is understood that a conventional ballast circuit is disposed in the subhousing 20 and functions in a conventional manner that will be described later.

A bottom plate 24 extends between the two side plates 16 and 18 and in a spaced relation to the center plate 14. The bottom plate 24 is formed by an elongated flat plate that is bent in two planes to form a center plate 24a and two side plates 24b and 24c extending from the respective sides of the center plate and at an angle to the center plate. The length of the bottom plate is substantially equal to the length of the top plate 12.

The side plates 24b and 24c extend substantially perpendicular to the side plates 14 and 16, respectively, and two opposed, distal, longitudinal marginal edge portions of the side plates 24b and 24c are connected to the side plates 16 and 18, respectively, in any conventional manner, such as by inserting the latter edge portions underneath tabs (not shown) extending from respective inner surfaces of the side plates 16 and 18 in a conventional manner.

An end cap 30 engages the corresponding ends of the plates 12 and 24, and an end cap 32 engages the other corresponding ends of the latter plates. The end caps 30 and 32 are attached to the respective ends of the bottom plate in any conventional manner, such as by sheet metal screws, bolts, or the like, that are inserted through aligned openings in the end caps and in tabs (not shown) extending from the respective ends of the bottom plate.

A pair of spaced sockets 34a and 34b (FIG. 1) are disposed at one end of the bottom plate 24, and a pair of spaced sockets 36a and 36b are disposed at the other end of the bottom plate. The sockets 34a, 34b, 36a and 36b, are secured to their respective ends of the side plates 24b and 24c by providing slots on the sides of each socket into which corresponding tabs formed on the latter plates extend, in a conventional manner.

A pair of electrical conductors 40a and 40b connect the sockets 34a and 34b, respectively, to the ballast circuit in the subhousing 20, and a pair of electrical conductors 42a and 42b connect the socket 36a to the latter circuit. Also, a pair of electrical conductors 44a and 44b connect the socket 36b to the circuit in the subhousing 20, and an electrical conductor 46 connects the sockets 34a and 34b.

A cable 48 extends through an opening in the plate 14 and consists of two conductors 48a and 48b which are separated inside the plate and are connected to the socket 34a and to the circuit in the subhousing 20, respectively. The conductors 48a and 48b of that portion of the cable 48 extending outside the end cap 32 are covered with an insulative sheath, and the end of the cable extending outside the end cap is adapted to be connected to a source of AC power.

Two conventional, elongated, fluorescent bulbs 50 and 52 are mounted in the fixture 10. The bulb 50 has two pins 50a and 50b extending out from its respective ends, and the bulb 52 has two pins 52a and 52b extending out from its respective ends. As better shown in FIG. 3, the bulb 50 is inserted in the space defined between the side plates 16 and 24b of the top plate 12 and of the bottom plate 24, respectively; and the bulb 52 is disposed in the space defined between the side plates 18 and 24c. The pins 50a and 50b of the bulb 50 are inserted in the sockets 34a and 36a, respectively; and the pins 52a and 52b of the bulb 52 are inserted in the sockets 34b and 36b, respectively, in a conventional manner, to establish an electrical connection between the bulbs and the sockets and therefore between the sockets and the ballast circuit in the subhousing 20.

The aforementioned ballast circuit in the subhousing 20 receives AC power from the cable 48 and functions in a conventional manner to provide a relatively high starting voltage between the sockets 34a and 36a, and between the sockets 34b and 36b, via the conductors 40a, 40b, 42a, 42b, 44a, 44b, and 46, to turn on the bulbs 50 and 52, respectively, and then provide a relatively low voltage for normal operation of the bulbs.

It is noted that the fixture 10 has a relatively low profile, or height, as well as a relatively small width since a single subhousing 20 is provided that is connected to the inner surface of the center plate 14 of the top plate 12 near the center of the latter plate; and since the bottom plate 24 is shaped to envelope the subhousing 20 yet define spaces for the two bulbs 50 and 52 between it and the respective side plates 16 and 18. Thus, the fixture 10 has a height and width of approximately 2.9 inches and 4.8 inches, respectively, and yet accommodates a standard-diameter fluorescent bulb; while the height and width of a typical prior art fixture for the same size bulb are approximately 5 inches and 7 inches, respectively. Thus, assuming that the bulbs 50 and 52 are approximately 48 inches in length, the fixture 10 enjoys a bulb length-to-fixture height ratio of approximately 16.5, and a bulb length-to-fixture width of approximately 10 which ratios are relatively high when compared to standard prior art fixtures of this type. This results in a relatively compact package that is easy to handle and install yet is inexpensive to ship, especially in bulk, when compared to prior art fixtures of the same type.

It is understood that variations may be made in the foregoing without departing from the scope of the invention. For example, the number of sockets, and therefore, the number of bulbs can be varied from the amount shown and described above. Also, the specific design of the sockets 14a, 14b, 16a and 16b and the electrical wiring can be changed, as long as an electrical connection is established with the bulbs 50 and 52. Further, the side plates 16 and 18 do not have to be formed integrally with the center plate 14, and the side plates 24b and 24c do not have to be formed integrally with the center plate 24a, but rather can be formed separately and connected to the center plates along the corresponding side edges of the plates in any conventional manner.

It is also understood that spatial references, such as “vertical”, “between”, “end”, “side”, “angled”, etc. are for the purpose of illustration only and do not limit the specific orientation or location of the structure described above.

Although only a few exemplary embodiments of this invention have been described in detail above, those skilled in the art will readily appreciate that many other modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents, but also equivalent structures.

What is claimed is:

1. A lighting fixture comprising a housing comprising a top plate and a bottom plate defining a space therebetween, a subhousing for a ballast circuit extending in the space between the top plate and the bottom plate, the bottom plate being formed by a center portion extending parallel and spaced with respect to at least a portion of the top plate and two side portions extending at an angle to the center portion, two end caps engaging the respective ends of the top plate and the bottom plate, at least one socket secured between each end of the bottom plate and the corresponding end plate for receiving the corresponding end of a fluorescent bulb, and electrical conductors connecting the ballast circuit to the sockets for supplying electrical current to the sockets and the bulb.

2. The fixture of claim 1 wherein the top plate comprises a center plate and two side plates respectively extending from the opposed longitudinal edges of the center plate.

3. The fixture of claim 2 wherein a bulb is disposed in the space defined between a side plate and one angled portion of the bottom plate, and another bulb is disposed in the space defined between the other side plate and the other angled portion of the bottom plate.

4. The fixture of claim 2 wherein there are two parallel, spaced bulbs, and wherein the top plate and the bottom plate are shaped to envelope the subhousing and define spaces for the bulbs, wherein the subhousing extends between the top plate and the bottom plate, wherein one bulb extends between one side plate and a one angled portion of the bottom plate, and wherein the other bulb extends between the other side plate and the other angled portion of the bottom plate.

5. The fixture of claim 2 wherein the subhousing is connected to the inner surface of the center plate of the top plate between the ends of the center plate.

6. The fixture of claim 2 wherein the respective edge portions of the bottom plate extend underneath tabs extending from the respective inner surfaces of the side plates to secure the bottom plate to the side plates.

7. The fixture of claim 1 wherein the width of the subhousing is less than the distance between the angled portions of the bottom plate and the height of the subhousing is less than the height of each of the side plates.

8. The fixture of claim 1 wherein there are two parallel, spaced bulbs, and wherein the top plate and the bottom plate are shaped to envelope the subhousing and define spaces for the bulbs.

9. The fixture of claim 1 wherein there are two sockets secured between each end of the bottom plate and the corresponding end plate, and wherein there are two bulbs, each extending between two corresponding sockets.

10. The fixture of claim 1 wherein the ratio of the length of the bulb to the height of the fixture is approximately 16.

11. The fixture of claim 1 wherein the ratio of the length of the bulb to the width of the fixture is approximately 10.

12. A method of manufacturing a lighting fixture comprising providing a bottom plate having at least a portion extending in a spaced relation to a top plate, securing a subhousing for a ballast circuit in the space between the top plate and the bottom plate, shaping the bottom plate to form a center portion extending parallel and spaced with respect to at least a portion of the top plate and two angled portions extending at an angle to the center portion, connecting two end caps to the respective ends of the top plate and the bottom plate, securing at least one socket between each end of the bottom plate and the corresponding end plate for receiving the corresponding end of a fluorescent bulb, and electrically connecting the ballast circuit to the sockets for supplying electrical current to the sockets and the bulb.

13. The method of claim 12 wherein the top plate is formed by a center plate and two side plates respectively extending from the opposed longitudinal edges of the center plate.

14. The fixture of claim 13 further comprising providing a bulb in the space defined between a side plate and one angled portion of the bottom plate, and providing another bulb in the space defined between the other side plate and the other angled portion of the bottom plate.

15. The method of claim 13 further comprising connecting the subhousing to the inner surface of the center plate between the ends of the center plate.

16. The method of claim 13 further comprising forming the side plates integrally with the center plate.

17. The method of claim 13 wherein the width of the subhousing is less than the distance between the angled portions of the bottom plate and wherein the height of the subhousing is less than the height of each side plate.

18. The method of claim 12 further comprising extending the respective edge portions of the bottom plate underneath tabs extending from the respective inner surfaces of the side plates to secure the bottom plate to the side plates.

19. The method of claim 12 wherein there are two sockets secured between each end of the bottom plate and the corresponding end plate, and wherein there are two bulbs, each extending between two corresponding sockets.

20. The method of claim 12 wherein there are two parallel, spaced bulbs, and further comprising shaping the top plate and the bottom plate to envelope the subhousing and define spaces for the bulbs.

21. A lighting fixture comprising a housing comprising a top plate and a bottom plate defining a space therebetween, a subhousing for a ballast circuit extending in the space between the top plate and the bottom plate, two end caps disposed at the respective ends of the plates, two sockets secured between each end of the bottom plate and the corresponding end plate for receiving the corresponding ends of two spaced, parallel fluorescent bulbs, and electrical conductors connecting the ballast circuit to the sockets for supplying electrical current to the sockets and the bulbs, the top plate and the bottom plate being shaped to envelope the subhousing and define spaces for the bulbs.

22. The fixture of claim 1 wherein the top plate comprises a center plate and two side plates respectively extending from the opposed longitudinal edges of the center plate.

23. The fixture of claim 22 wherein the bottom plate comprises a center plate extending in a spaced relation to the center plate of the top plate, and two side plates extending at an angle to the center plate of the bottom plate.

24. The fixture of claim 22 wherein the side plates of the bottom plate extend substantially perpendicular to the side plates of the top plate.
